(19) United States
(12) Patent Application Publication
(10) Pub. No.: US 2009/0160677 A1
(43) Pub. Date: Jun. 25, 2009

(54) Dynamic Traffic Announcement

(75) Inventors: Kevin Langley Gallichan, London (GB); Dean Anthony Miles, Kent (GB); Nick James Robberts, Warwickshire (GB)

Correspondence Address: DICKINSON WRIGHT PLLC, 1875 Eye Street, NW, Suite 1200, WASHINGTON, DC, 20006, US

(73) Assignee: VISTEON GLOBAL TECHNOLOGIES, INC., Van Buren Township, MI (US)

(21) Appl. No.: 12/323,990

(22) Filed: Nov. 26, 2008

(30) Foreign Application Priority Data
Nov. 27, 2007 (GB) 0723301.8

(51) Int. Cl. G08G 1/095

(52) U.S. Cl. 340/908

(57) ABSTRACT

A traffic announcement system for a motor vehicle utilizes a vehicular navigation system covering a geographical area, a receiver that receives traffic announcement signals, an in-vehicle audio system for presenting to a driver of the vehicle the received traffic announcements, and a controller linked to the navigation system and to the receiver. Via the controller the driver of the vehicle can selectively suppress the presentation of at least some traffic announcements. The controller includes a user input by which the driver identifies particular routes or localities within the geographical area covered by the navigation system for which traffic announcements are to be selectively suppressed. The controller then automatically suppresses the traffic announcements when the vehicle is on the identified routes or within the identified localities. The driver can also input selected time ranges when traffic announcements are to be suppressed.

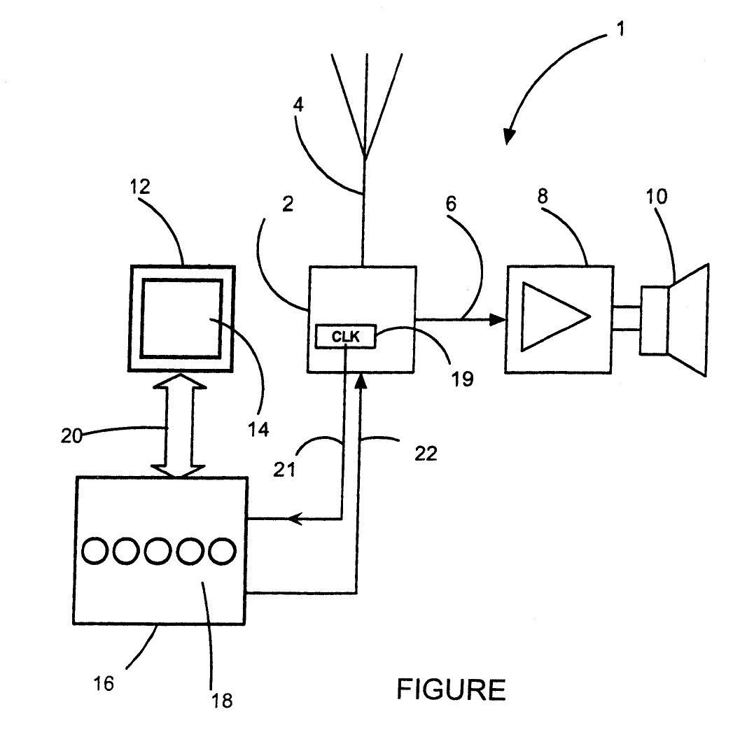

### FIELD OF THE INVENTION

The present invention relates to the field of receiving audible traffic alerts or announcements while traveling in a motor vehicle.

### BACKGROUND INFORMATION

Radio receivers in motor vehicles are often fitted with circuitry for receiving digitally encoded traffic alerts or announcements. For sake of simplicity, these digitally encoded traffic alerts or announcements are referred to in this disclosure as “traffic announcements.” The motor vehicle's audio or entertainment system can be set to automatically output or switch to a traffic announcement. Because a driver will, in general, not always need to receive such announcements, a control is provided so that the driver can switch traffic announcements on or off.

Because traffic announcements are broadcast over a wide area, it is often the case then even when a particular driver desires to receive relevant traffic announcements, most traffic announcements will be irrelevant to that driver's journey. Traffic announcements may be irrelevant to the journey concerned for a number of reasons. One of these is that the announcement concerns a road along which or an area in which the driver does not intend to pass.

One proposed solution to this problem receives digitally encoded information in the traffic announcement that identifies the route concerned and then compares this with a desired route to be taken by the driver. If the announcement does relate to the desired route, then the announcement is audibly presented to the driver. For details of this proposal, refer to U.S. Pat. No. 5,095,532.

While such a system may be effective when the driver is taking a specific journey along a desired route, the driver may still receive unnecessary or unwanted traffic announcements. Examples of situations in which the driver may not benefit from a traffic announcement include instances where: the driver is in an area which he knows well, and for which there are multiple alternative routes to his chosen destination; the driver is near his destination and there are no longer any alternative routes which may be taken; the driver is on a minor road for which there would be no traffic announcements; and the driver is driving in rush hour conditions in city traffic where delays are predictable. In any of these situations, traffic announcements will provide little or no useful information to a driver of a vehicle. In order to avoid unnecessary interruptions, the driver may then manually switch off the traffic announcements, while continuing to listen to the radio or other audio sources such as a CD player.

This is inconvenient for two reasons. Firstly, the driver will not usually remember to switch the traffic announcements off until after an unwanted traffic announcement has already disturbed his listening pleasure. Secondly, the driver may at a later occasion forget to turn the traffic announcements back on prior to taking a journey during which traffic announcement would have provided useful traffic information. It is because of this second risk that a driver may decide to endure unwanted traffic announcements so that he does not have to remember to switch the traffic announcements back on at a later date.

What is needed is a traffic announcement system for a motor vehicle that addresses these issues.

### SUMMARY OF THE INVENTION

One embodiment of the present invention provides a traffic announcement system for a motor vehicle. The system has a receiver that receives traffic announcement signals, an in-vehicle audio system that presents to the driver of the vehicle the received traffic announcements, and a controller linked to the receiver by which the driver of the vehicle may selectively suppress the presentation of at least some traffic announcements. The controller includes a driver input by which the driver may identify one or more particular times of day during which the traffic announcements are to be selectively suppressed. The controller then automatically suppresses the traffic announcements during the driver identified times.

The input times of day may be any times within the 24 hours of a of day, but will most commonly be either rush hour times of day, or any other times during daylight or night time hours when a driver normally expect to be driving a route or to a destination for which he feels that traffic announcements will not be helpful. The user will then be spared traffic announcements during the identified time of day for which the driver has indicated via the driver input that he does not wish to receive any traffic announcement.

The controller may include a driver input by which the driver may assign one of a plurality of weightings to particular time of day. The controller may additionally include a driver input by which the driver may additionally set a threshold related to the input weightings so that the controller then automatically suppresses traffic announcements at a particular time of day only if the weighting for that time of day is above the set threshold.

The system may additionally include a vehicular navigation system covering a geographical area. The controller is then linked to the navigation system, and includes a driver input by which the driver may identify particular routes or localities within the geographical area covered by the navigation system for which the traffic announcements are to be selectively suppressed. The controller then automatically suppresses traffic announcements when the vehicle is on these driver identified routes or within these driver identified localities during the driver identified times.

Another embodiment of the present invention provides a traffic announcement system for a motor vehicle that includes a vehicular navigation system covering a geographical area, a receiver that receives traffic announcement signals, an in-vehicle audio system that presents to the driver of the vehicle the received traffic announcements, and a controller linked to the navigation system and to the receiver by which the driver of the vehicle may selectively suppress presentation of at least some traffic announcements. The controller includes a driver input by which the driver may identify particular routes or localities within said geographical area covered by the navigation system for which said traffic announcements are to be selectively suppressed. Once identified, the controller then automatically suppresses traffic announcements when the vehicle is on the identified routes or within the identified localities. The user will then be spared traffic announcements when his vehicle is on the particular routes or within the particular localities for which the driver has indicated via the driver input that he does not wish to receive any traffic announcement.

Another aspect of the traffic announcement system is a user switch by which the driver may turn off all traffic announcements. The same switch can then be used to turn on the non-suppressed traffic announcements so that these are presented to the driver of the vehicle. Optionally, the same, or another, user switch or control may be used to disable or over-ride the selective suppression of the traffic announcements, so that a driver of the vehicle always has the option of receiving all traffic announcements. Therefore, one or more user controls may be provided to permit a driver to turn off all traffic announcements, turn on all traffic announcements, or to enable said selective suppression of traffic announcements.

The driver identified localities may include an area around a driving destination, for example a circular area centered on the destination, in which case it would only be necessary for a driver to indicate the radius or diameter of such an area. This is helpful because once a driver is sufficiently close to his destination, it becomes increasingly unlikely that any traffic announcement will in fact concern his journey. Even if a traffic announcement is made that does concern the route taken or the locality around the destination, the driver may not benefit from hearing the traffic announcement. For example, the driver may know his way around the destination well enough that it is easy to identify a different route if it has become clear that the traffic is bad along his current route. Alternatively, it is often the case that there will be only one sensible route to a destination once the destination is sufficiently close by. In either case, a traffic announcement, even if it does concern the route or the locality around the destination, will be of limited or no value to the driver, and can therefore safely be suppressed.

When the driver then at a later time, sets off on a different journey, it is no longer necessary for the driver to remember to switch the traffic announcements on, as this functionality has always been “on”, but only suppressed for those identified routes or localities relevant to the previous journey in the motor vehicle.

The controller may includes a driver input by which the driver may additionally identify one or more particular times of day during which the traffic announcements are to be selectively suppressed. This can be helpful if the driver knows that at certain times of day, for example during rush hour, that the traffic is likely to be bad along his route or over the geographical area over which his radio typically receives traffic announcements. In this case, the driver is spared regular interruptions of traffic announcements which do not convey useful information. In this case, the selective suppression of traffic announcements requires that the vehicle is on the identified routes or within the identified localities during those times of day.

The controller may include a user input by which the driver may identify a particular driving direction along the identified routes, for which the traffic announcements are to be selectively suppressed. The controller then automatically suppresses the traffic announcements when the vehicle is on those routes and driving along those particular driving directions.

The controller may include an adaptive controller linked to the vehicular navigation system and arranged to automatically identify from driving patterns the most common routes and destinations used by the driver. The controller then may include a user input by which the driver may control the automatic suppression of the traffic announcements for these most common routes and destinations.

These controller modes of operation are particularly useful in suppressing unwanted traffic announcements in areas close to where a driver lives or works, for it is in these areas that the driver is likely to know any alternative routes, and to be familiar with traffic patterns.

The controller may include a user input by which the driver may assign one of a plurality of weightings to particular routes or localities within the geographical area covered by the navigation system. The controller then additionally includes a driver input by which the driver may additionally set a threshold related to these weightings so that the controller then automatically suppresses the traffic announcements only if the weighting for these routes or within these localities is above this threshold.

Another embodiment of the present invention provides a method of controlling the presentation of radio traffic announcements to the driver of a motor vehicle that has an electronic timekeeping device, a radio transmission receiver, an in-vehicle audio system, and a controller linked to the electronic timekeeping device and to the receiver. The method includes steps of using the radio receiver to receive traffic announcement signals and inputting into the controller particular times of day for which said traffic announcements are to be selectively suppressed. The method also includes steps of using the electronic timekeeping device to generate an actual time of day; comparing the particular times of day with the actual time of day; and using the controller to automatically suppress the presentation of the traffic announcements by the audio system when the actual time of day corresponds with the particular times of day.

Still another embodiment of the invention provides a method of controlling the presentation of radio traffic announcements to the driver of a motor vehicle that has a vehicular navigation system covering a geographical area, a radio transmission receiver, an in-vehicle audio system, and a controller linked to the navigation system and to the receiver. The method includes the steps of using the radio receiver to receive traffic announcement signals, and inputting into the controller particular routes or localities within the geographical area covered by the navigation system for which the traffic announcements are to be selectively suppressed. The method further includes the step of using the controller to automatically suppress the presentation of the traffic announcements by the audio system when the vehicle is on the routes or within the localities.

Further scope of applicability of the present invention will become apparent from the following detailed description, claims, and drawing. However, it should be understood that the detailed description and specific examples, while indicating exemplary embodiments of the invention, are given by way of illustration only, since various changes and modifications within the spirit and scope of the invention will become apparent to those skilled in the art.

### BRIEF DESCRIPTION OF THE DRAWING

Other advantages of the present invention will be readily appreciated and more fully understood by reference to the following detailed description when considered in connection with the accompanying drawing wherein:

The FIGURE is a schematic block diagram showing the components of a traffic announcement system according to embodiments of the invention.

### DETAILED DESCRIPTION OF THE INVENTION

The FIGURE shows a traffic announcement system 1 for a motor vehicle. The system is based around a radio receiver 2 that has an input connected to a radio antenna 4 for receiving terrestrial radio signals, some of which will carry in additional to their normal program content traffic announcement (TA) signals. For example, TA signals may be received according to the analog FM-RDS TA format. The radio receiver 2 provides an output 6 to an amplifier 8 which is conventionally integrated with other conventional audio or audio visual components, for example a CD player (not shown). A speaker system 10 is connected to an output of the amplifier 8. The amplifier 8 and speaker system 10 together form an in-vehicle audio system for presenting audible entertainment or information to the driver. The radio also includes an electronic clock (CLK) 19.

The TA system 1 also includes a vehicular navigation system 12 covering a geographical area. The navigation system will normally be a satellite navigation (satnav) system. Although not illustrated for reasons of clarity, the satnav system may, as is well known to those skilled in the art, receive positioning signals from the GPS satellite network, and may also rely on an inertial guidance system that receives inputs from vehicular movement and speed sensors. A vehicle in the United Kingdom may, for example, have a satellite navigation system covering the entire United Kingdom and Ireland.

When the satnav system is actively being used to guide the driver, map information will be displayed on a screen 14. The driver can interact with the satnav system in various known ways. For example, the screen may be a touch screen that the driver can press to enter information and to control the operation of the satnav system.

The TA system 1 also includes a controller 16 linked to the satnav 12 by means of a bidirectional data communications bus 20 and to the radio receiver 2 by means of two lines 21, 22, one of which receives a clock signal from the clock 19 and the other of which 22 carries a signal to the radio receiver so that the driver of the vehicle may selectively suppress the audible presentation of at least some of the received traffic announcements. The controller 16 may be physically integrated into the satnav unit 12, and in order to provide a driver input by which the driver may identify particular routes or localities within the geographical area covered by the satnav system 12, the controller 16 may share control features such as knobs, buttons or a touch screen used to control the route guidance functionality of the satnav system. It is therefore only for reasons of convenience and clarity of exposition that the controller 16 is illustrated in the schematic drawings as being physically separate from other components of the TA system 1.

In any event, the controller includes a user input 18 by which the driver may identify particular times of day and/or particular routes or localities within the geographical area covered by the satnav system 12 for which the traffic announcements are to be selectively suppressed. The identity of these times and/or routes and/or localities is then stored within the controller 16. The controller 16 then receives from the radio receiver 2, via line 21, the actual time and from the satnav 12, via the bus 20, data indicating the route and/or locality of the vehicle, which may include related information such as the direction of travel along a road. The controller 16 then compares this received information with the previously entered information stored in the controller 16 relating to times or routes or localities for which traffic announcements are to be suppressed.

If there is a match, then the controller sends a signal 22 to the radio receiver 2 to automatically suppress the traffic announcements during the identified times and/or when the vehicle is on or in these identified routes or localities.

One of the user controls 18 may be a switch by which the driver may turn off all traffic announcements. The same switch can then be used to turn on traffic announcements so that those which are not suppressed can be presented to the driver of the vehicle. Optionally, the same, or another, switch or user control may be used to disable or over-ride the selective suppression of the traffic announcements, so that a driver of the vehicle always has the option of receiving all traffic announcements.

The embodiment described above may contain any of the other optional features of the invention described above in order to provide greater flexibility in determining under what conditions the traffic announcements are to be suppressed. For example, the user controls 18 may enable the driver to enter times of day during which traffic announcements should not be suppressed, or to assign weightings to the entered times of day or routes or localities so that the user can later on use these weightings in the selection of when or where the traffic announcements are not to be presented audibly to the driver.

Optionally, a visible indication may be provided, for example a message displayed on the satnav screen 14, informing the driver when a traffic announcement has been received and then suppressed by the system 1. This at least gives the driver an option of manually over-riding the TA suppression, if he is concerned that the traffic announcement might be useful or relevant.

A particular advantage of the invention is that it is not necessary to receive TMC digitally encoded traffic announcement signals, as is the case with the system disclosed in U.S. Pat. No. 5,095,532. In such known systems, it is necessary to use digitally encoded traffic announcements and then compare the data in such announcements with data from an in-vehicle navigation system. Apart from the inherent complexity, such a system cannot fully suppress traffic announcements when the driver is on a route or in a locality legitimately covered by such a traffic announcement. In contrast, the invention can make use of the more widely available analog FM-RDS TA announcements, and in such a way that the driver is assured that traffic announcements are fully suppressed when these are not required for whatever reason when a driver is on a particular route or within a particular locality.

The invention therefore provides a convenient and flexible traffic announcement system for a motor vehicle in which unwanted traffic announcements are effectively suppressed.

The foregoing discussion discloses and describes embodiments of a traffic announcement system. It will be understood by those skilled in the art that the present invention may be embodied in other specific forms without departing from the scope of the invention disclosed and that the examples and embodiments described herein are in all respects illustrative and not restrictive. Those skilled in the art of the present invention will recognize that other embodiments using the concepts described herein are also possible. Further, any reference to claim elements in the singular, for example, using the articles “a,” “an,” or “the” is not to be construed as limiting the element to the singular.

What is claimed is:

1. A traffic announcement system for a motor vehicle, the system comprising:
a receiver for receiving traffic announcement signals;
an in-vehicle audio system for presenting to a driver of the vehicle the received traffic announcements; and
a controller, linked to the receiver, by which a user selectively suppresses the presentation of at least some traffic announcements, wherein the controller comprises a user input by which the user identifies one or more particular times of day during which the traffic announcements are to be selectively suppressed, the controller then automatically suppressing the traffic announcements during the user identified times.

2. A traffic announcement system as claimed in claim 1, in which the user input of the controller accepts input by the user to assign one of a plurality of weightings to particular time of day, as well as input by the user to set a threshold related to the weightings so that the controller then automatically suppresses the traffic announcements at a particular time of day only if the weighting for the time of day is above the threshold.

3. A traffic announcement system as claimed in claim 1, further comprising:
a vehicular navigation system covering a geographical area, the controller being linked to the navigation system;
wherein the user input of the controller accepts input by the user to identify particular routes or localities within the geographical area covered by the navigation system for which the traffic announcements are to be selectively suppressed, the controller then automatically suppressing the traffic announcements when the vehicle is on the identified routes or within the identified localities during the user identified times.

4. A traffic announcement system for a motor vehicle, the system comprising:
a vehicular navigation system covering a geographical area;
a receiver for receiving traffic announcement signals;
an in-vehicle audio system for presenting to a driver of the vehicle the received traffic announcements; and
a controller, linked to the navigation system and to the receiver, by which a user selectively suppress presentation of at least some traffic announcements, wherein the controller comprises a user input by which the user identifies particular routes or localities within the geographical area covered by the navigation system for which the traffic announcements are to be selectively suppressed, the controller then automatically suppressing the traffic announcements when the vehicle is on the identified routes or within the identified localities.

5. A traffic announcement system as claimed in claim 4, in which the user identified localities include an area around a driving destination.

6. A traffic announcement system as claimed in claim 4, wherein the user input of the controller accepts input by the user to identify one or more particular times of day during which the traffic announcements are to be selectively suppressed.

7. A traffic announcement system as claimed in claim 6, in which the selective suppression of traffic announcements requires that the vehicle is on the identified routes or within the identified localities during the identified times of day.

8. A traffic announcement system as claimed in claim 3, wherein the user input of the controller accepts input by the user to identify a particular driving direction along the identified routes, for which the traffic announcements are to be selectively suppressed, the controller then automatically suppressing the traffic announcements when the vehicle is on the identified routes and moving in the identified particular driving directions.

9. A traffic announcement system as claimed in claim 3, wherein the controller further comprises:
an adaptive controller linked to the vehicular navigation system and arranged to automatically identify from driving patterns the most common routes and destinations used by the driver;
wherein the user input of the controller accepts user input to control the automatic suppression of said traffic announcements for the most common routes and destinations.

10. A traffic announcement system as claimed in claim 3, wherein the user input of the controller accepts user input by which the user assigns one of a plurality of weightings to particular routes or localities within the geographical area, as well as user input by which the user sets a threshold related to the weightings so that the controller then automatically suppresses the traffic announcements when the vehicle is on the weight assigned routes or within the weight assigned localities only if the weighting for the weight assigned routes or within the weight assigned localities is above the set threshold.

11. A traffic announcement system as claimed in claim 3, further comprising a user control input selected from the group consisting of:
a user control input connected to the controller to accept input from the user to turn off all traffic announcements;
a user control input connected to the controller to accept input from the user to turn on all traffic announcements; and
a user control input connected to the controller to accept input from the user to enable said selective suppression of traffic announcements.

12. A method of controlling the presentation of radio traffic announcements to the driver of a motor vehicle, the vehicle comprising an electronic timekeeping device, a radio transmission receiver, an in-vehicle audio system, and a controller linked to the electronic timekeeping device and to the receiver; the method comprising the steps of:
receiving traffic announcement signals via the radio receiver;
inputting into the controller particular times of day for which the traffic announcements are to be selectively suppressed;
generating an actual time of day using the electronic timekeeping device;
comparing the particular times of day with the actual time of day; and
suppressing automatically, using the controller, the presentation of the traffic announcements by the audio system when the actual time of day corresponds with the particular times of day.

13. A method of controlling the presentation of radio traffic announcements to the driver of a motor vehicle, the vehicle comprising a vehicular navigation system covering a geographical area, a radio transmission receiver, an in-vehicle audio system, and a controller linked to the navigation system and to the receiver; the method comprising the steps of:
receiving traffic announcement signals using the radio receiver;
inputting into the controller particular routes or localities within the geographical area covered by the navigation system for which the traffic announcements are to be selectively suppressed; and
suppressing automatically, using the controller, the presentation of the traffic announcements by the audio system when the vehicle is on the inputted routes or within the inputted localities.
